(19) United States
(12) Patent Application Publication
(10) Pub. No.: US 2014/0351838 A1
(43) Pub. Date: Nov. 27, 2014

(54) SYSTEM AND METHOD FOR PROVIDING A SECURE ACCESS-CONTROLLED ENTERPRISE CONTENT REPOSITORY

(71) Applicants: Andrew Dunmore, Chicago, IL (US); Carl Franklin, Munster, IN (US); Jason Lee, Western Springs, IL (US); Jason Ruge, Studio City, CA (US)

(72) Inventors: Andrew Dunmore, Chicago, IL (US); Carl Franklin, Munster, IN (US); Jason Lee, Western Springs, IL (US); Jason Ruge, Studio City, CA (US)

(21) Appl. No.: 14/285,195

(22) Filed: May 22, 2014

Related U.S. Application Data
(60) Provisional application No. 61/826,301, filed on May 22, 2013.

(51) Int. Cl. H04N 21/475; H04N 21/4627; H04N 21/488; H04N 21/442

(52) U.S. Cl. CPC H04N 21/475; H04N 21/44204; H04N 21/4627; H04N 21/488
USPC 725/14

(57) ABSTRACT

The disclosed system provides enables controlling access to content, such as videos, based on authentication information provided by a user of the system. In one embodiment, after authenticating a user, the system provides a database of media, such as corporate training videos, the scope of which is determined based on the identity of the user. The system enables the user to view and provide feedback about videos, such as by indicating a rating of the video and/or providing comments about the video. The system also enables the content provider to specify searchable information for various videos, such as title, creation date, run time, or other appropriate information. The system enables the creator to specify certain metadata about content, to provide further information that can be searched by users of the system. The disclosed system may also enable users to share videos with other users with similar access rights.

### PRIORITY CLAIM

This application is a non-provisional of, and claims priority to and the benefit of U.S. Provisional Patent Application No. 61/826,301, filed on May 22, 2013, which is incorporated by reference herein in its entirety.

### COPYRIGHT NOTICE

A portion of the disclosure of this patent document contains material that is subject to copyright protection. The copyright owner has no objection to the photocopy reproduction of the patent document or the patent disclosure in exactly the form it appears in the Patent and Trademark Office patent file or records, but otherwise reserves all copyright rights whatsoever.

### TECHNICAL FIELD

The present disclosure relates in general to a system and method for providing users with access to a database of media files in a secure, authenticated environment. More specifically, the present disclosure relates to enabling users to log in to a secure video repository to access, view, and/or interact with a set of videos determined based on the authentication information.

### BACKGROUND

Known video distribution systems provide all users with access to databases of videos regardless of the user. For example, known systems serve as databases of video files, and enable users to search for and view videos as desired. In various known systems, users can provide search terms that search file names, file attributes, and/or metadata about a video. Alternatively, in known systems, users can view videos by clicking on a hyperlink to a video provided from another source, such as another website or in an email. Such systems are deficient, however, because access to videos cannot be controlled. As a result, content generators are reluctant to post videos that contain information that may be sensitive and/or that the content generator does not wish to make public.

Other known systems provide a capability for a measure of privacy by providing a system in which not all videos can be searched. In these systems, all videos in a video repository are accessible by any user; however, users cannot search for certain so-called private videos. These systems control access to such private videos by requiring a user to enter a specific URL to link a user to a private video. Such private videos are advantageous in that users are less likely to accidentally view the private videos. However, these known systems are nonetheless deficient because a link to a video can be easily copied and distributed to recipients for whom the video content was not intended.

It is an advantage of the present disclosure to provide a system for controlling access to video resources based on authentication information for a viewer. It is a further advantage of the present disclosure to enable a user to log in to a video database system in which the universe of videos available to the user is determined based on the user's authentication information. It is a further advantage of the disclosed system to associate data, such as metadata and/or user-provided feedback data, with video content in an enterprise video system. As a result, it is an advantage of the present disclosure to provide an enterprise video distribution system in which a particular enterprise can securely post videos for search, consumption, and comment by only users affiliated with the enterprise.

### SUMMARY

Various embodiments of the disclosed system enable media content generators (such as corporations or other organizations) to generate proprietary content (such as proprietary videos) and to distribute that proprietary content only to those users desired by the media content generator. In such embodiments, the disclosed system enables users wishing to access media served by the disclosed system to log in or otherwise provide authentication information. Thereafter, the disclosed system validates the user's identify, and upon validating, determines which media content to provide to the user based on his or her identity. In various embodiments, the system enables users to search a universe of videos to which they are authorized, such as a universe of videos provided to the user by his or her employer. This searching may be performed based on the title of the video, content of the video (e.g., descriptive elements of the video, theme of the video, format of the video, or length), or metadata about the video, for example. The disclosed system in various embodiments therefore provides media content generators with the peace of mind to know that videos or other media content created by the content generator can only be accessed and consumed by those individuals desired by the content generator.

In various embodiments, the system disclosed herein enables the content provider to create content and provide the content in a data store or database searchable by users to whom access is given. In one such embodiment, the system enables the content provider to provide a title of content, such as a video title, which can be searched by users of the system who have access to the video. In another embodiment, the disclosed system enables the content provider to provide metadata about a video, such as data about the video's creation date and time, the circumstances of creation of the video (e.g., a camera type used to create the video), a description of the content of the video, and the like. In various embodiments, while the metadata can be associated with the video, users with access to the content cannot see the metadata. Instead, in these embodiments, the metadata about uploaded videos is searchable but not visible. In other embodiments, some or all of the metadata may be visible to the users of the system.

In further embodiments, the disclosed system enables users to interact with media to which they are entitled. In one such embodiment, the disclosed system enables users to provide feedback about a video during or after viewing the video. In a further embodiment, the system enables users to comment in-line to not only a video, but also to the comments of other users who have previously viewed the video. In another embodiment, the disclosed system enables users to review and/or rate the content, such as by selecting a “thumbs-up” or “thumbs-down” icon associated with a particular video. In still another embodiment, the disclosed system enables users to share videos with other authorized users in a convenient way, such as through the use of so-called friendly or simplified URLs.

In various embodiments, the disclosed system further enables users to create and upload content to the disclosed media management system. In one such embodiment, the disclosed system enables a user to create content, such as by capturing video with a camera integrated into a mobile phone, and to upload the content to the disclosed system. In one such embodiment, user-created and uploaded content can be access-managed in the same way as the organization-created content discussed above. For example, in one embodiment the disclosed system enables a user to create content with his or her video camera, and upload the content such that it is viewable by the same group of users that share permissions with the uploading user. In a further embodiment, the disclosed system enables the uploading user to specify metadata about the content, which metadata can be used by other users to search the database of content.

### BRIEF DESCRIPTION OF THE FIGURES

FIG. 1 is a block diagram illustrating an example of the electrical systems of a device usable to implement the computerized content access control system disclosed herein.

FIG. 2 is an example screen shot of the media content management system disclosed herein, as viewed from the perspective of the user of the system.

FIG. 3 is an overall flow chart of an enterprise media distribution experience.

FIG. 4 illustrates some of the details of the user media browsing experience 400 provided by the disclosed system.

FIG. 5 is a flow chart of a series of blocks indicating enhancements provided by one embodiment of the disclosed system.

FIG. 6 is a flow chart of a series of blocks indicating upload functionality provided by one embodiment of the disclosed system.

FIG. 7 is a flow chart of a series of blocks indicating administrative system management functionality provided by one embodiment of the disclosed system.

FIG. 8 is a flow chart of a series of blocks indicating administrative system reporting functionality provided by one embodiment of the disclosed system.

FIG. 9 is a flow chart of a series of blocks indicating non-functional aspects of one embodiment of the disclosed system.

FIG. 10 is a flow chart of a series of blocks indicating a user media browsing metadata flow provided by one embodiment of the disclosed system.

FIG. 11 is a flow chart of a series of blocks indicating an upload process metadata capture flow provided by one embodiment of the disclosed system.

### DETAILED DESCRIPTION

The computerized content access system disclosed herein provides a robust media distribution system in which access to media can be controlled depending on a user's identity and other access parameters. As a result, the disclosed system advantageously provides a system that can be used by enterprises (companies, governments, professional associations, etc.) to distribute content that the enterprise wishes its members to see, but that the enterprise does not wish to distribute to the general public. In various embodiments, as described in detail below, the system enables the enterprise to specify which of its members receive access to subsets of media, and the system thereafter implements that access control scheme. The system also enables content creators and providers to specify information about uploaded content, such as a title of a video, a date of creation of a video, category of a video, etc., and organizes content to which a user has access based on those characteristics. In one such embodiment, videos are organized by channel wherein similar videos are provided in a single channel. In further embodiments, the disclosed system enables the content provider to specify so-called metadata, such as a description of the video, which can also be searched by users of the system. In some instances, the metadata is visible to the user; in other instances, it is not.

The disclosed computerized content access system also enables users to interact with the system and/or the media provided by the system. For example, the disclosed system in one embodiment enables a user to provide feedback, such as in the form of ratings or comments, which are visible to other users and the content provider. In various embodiments, the feedback is searchable, such as by enabling a user to search comments by string or to view videos based on feedback given by other users. In other embodiments, the disclosed system enables users to categorize media such that it appears in certain channels. In one embodiment, the system enables the user to create his or her own content and upload it to the system. For example, in one embodiment, the system enables a user to create a video with his or her mobile phone and upload it to the system such that other users can view it. In a further embodiment, the system enables a user creator of content to specify metadata and other information about uploaded content, such enables other users can search for user-created content. In one embodiment, the disclosed system provides for access control of user created content. For example, the disclosed system may provide access to content created by a user to other users in a same group or employed by a same employer as the creator of the content.

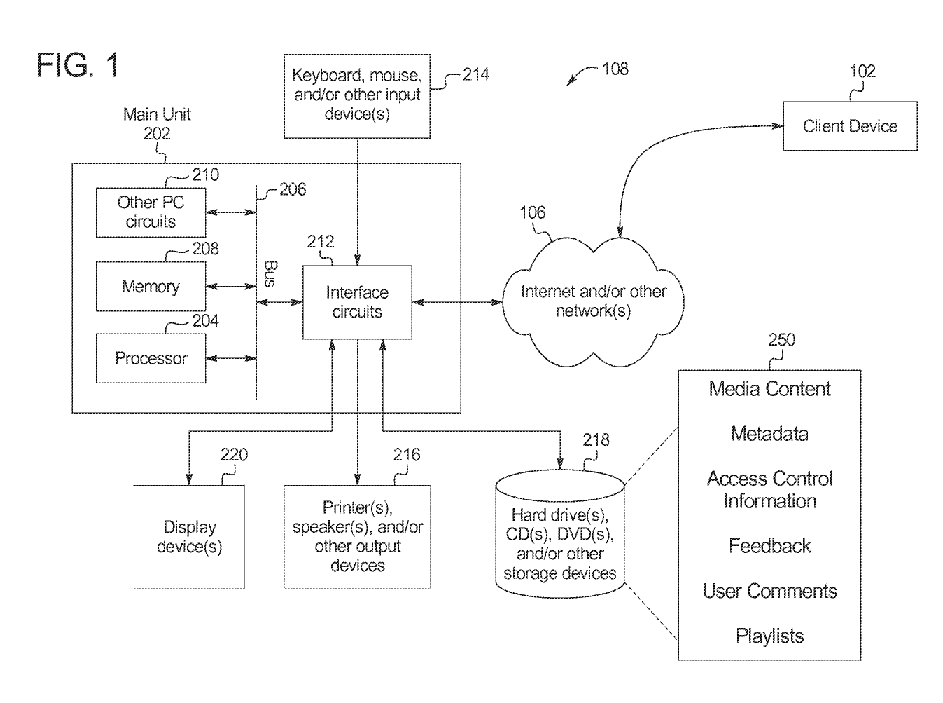

FIG. 1 is a block diagram illustrating an example of the electrical systems of a device (e.g., device 108) usable to implement the computerized content access control system disclosed herein. In one embodiment, the device 108 illustrated in FIG. 1 corresponds to a server of media content (e.g., videos) which enables users to log in, access, and interact with media content provided by a content provider. In this embodiment, the users and/or content providers interact with the device 108 using a suitable client device, such as client device 10.

In the example architecture illustrated in FIG. 1, the device 108 includes a main unit 202 which preferably includes one or more processors 204 electrically coupled by an address/data bus 206 to one or more memory devices 208, other computer circuitry 210, and/or one or more interface circuits 212. The one or more processors 204 may be any suitable processor, such as a microprocessor from the INTEL PENTIUM® family of microprocessors. PENTIUM® is a trademark registered to Intel Corporation and refers to commercially available microprocessors.

In one embodiment, device 108 includes memory 208. Memory 208 preferably includes volatile memory and non-volatile memory. Preferably, the memory 208 stores one or more software programs that interact with the hardware of the host device 108 and with the other devices in the system as described below. In addition or alternatively, the programs stored in memory 208 may interact with one or more client devices such as client device 102 to provide those devices with access to media content stored on the device 108. The programs stored in memory 208 may be executed by the processor 204 in any suitable manner.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system. In one embodiment, wherein the device 108 is designed to be operated or interacted with only via remote devices, the device 108 may not include input devices 214.

One or more displays 220, printers, speakers, and/or other output devices 216 may also be connected to the main unit 202 via the interface circuit 212. The display 220 may be a cathode ray tube (CRT), liquid crystal display (LCD), or any other type of display. The display 220 generates visual representations of data during operation of the device 108. For example, the display 220 may be used to display information about the database of media, to display information about users that have access to certain media, to review feedback about certain media, and/or to enable an administrator at the device 108 to interact with the media content in an administrative, debugging, or maintenance role.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 108, including the media content served to users of the disclosed system, as indicated by block 250. Alternatively, storage devices 218 may be implemented as cloud-based storage, such that access to the storage 218 occurs via an internet circuit such as an Ethernet circuit 212. In one example described in more detail below, the storage device 218 stores media content (such as videos), metadata about the media content, information indicating access to media content by a plurality of users, and feedback or other comments as provided by users upon consuming the media content., and/or playlist information.

In one embodiment, this connection of devices (i.e., the device 108 and the client device 102) is facilitated by a network connection over the Internet and/or other networks, illustrated in FIG. 1 by cloud 106. The network connection may be any suitable network connection, such as an Ethernet connection, a digital subscriber line (DSL), a WiFi connection, a cellular data network connection, a telephone line-based connection, a connection over coaxial cable, or another suitable network connection.

In one embodiment, device 108 is a device that provides cloud-based services, such as cloud-based authentication and access control, storage, streaming, and feedback provision. In this embodiment, the specific hardware details of device 108 are not important to the implementer of the disclosed system-instead, in such an embodiment, the implementer of the disclosed system utilizes one or more Application Programmer Interfaces (APIs) to interact with device 108 in a convenient way, such as to store uploaded content, define access control parameters, and create reports based on consumption of the content, as described in detail below.

Access to device 108 and/or client device 102 may be controlled by appropriate security software or security measures. An individual user's access can be defined by the device 108 and limited to certain data and/or actions, such as certain media content stored on the device 108, according to the individual's identity. Accordingly, users of the system may be required to register with the device 108 before accessing the content provided by the disclosed system.

In a preferred embodiment, each client device 102 has a similar structural or architectural makeup to that described above with respect to the device 108. That is, each client device 102 in one embodiment includes a display device, at least one input device, at least one memory device, at least one storage device, at least one processor, and at least one network interface device. It should be appreciated that by including such components, which are common to well-known desktop, laptop, or mobile computer systems (including smart phones, tablet computers, and the like), client device 102 facilitates interaction among and between each other by users of the respective systems.

In various embodiments, devices 102 and/or 108 as illustrated in FIG. 1 may in fact be implemented as a plurality of different devices. For example, the device 108 may in actuality be implemented as a plurality of server devices operating together to implement the media content access system described herein. In various embodiments, one or more additional devices, not shown in FIG. 1, interact with the device 108 to enable or facilitate access to content. For example, in one embodiment the device 108 communicates via network 106 with one or more public repositories of information, such as public media content databases, and/or one or more proprietary repositories of information, such as other enterprise media databases, to present a more robust media consumption experience.

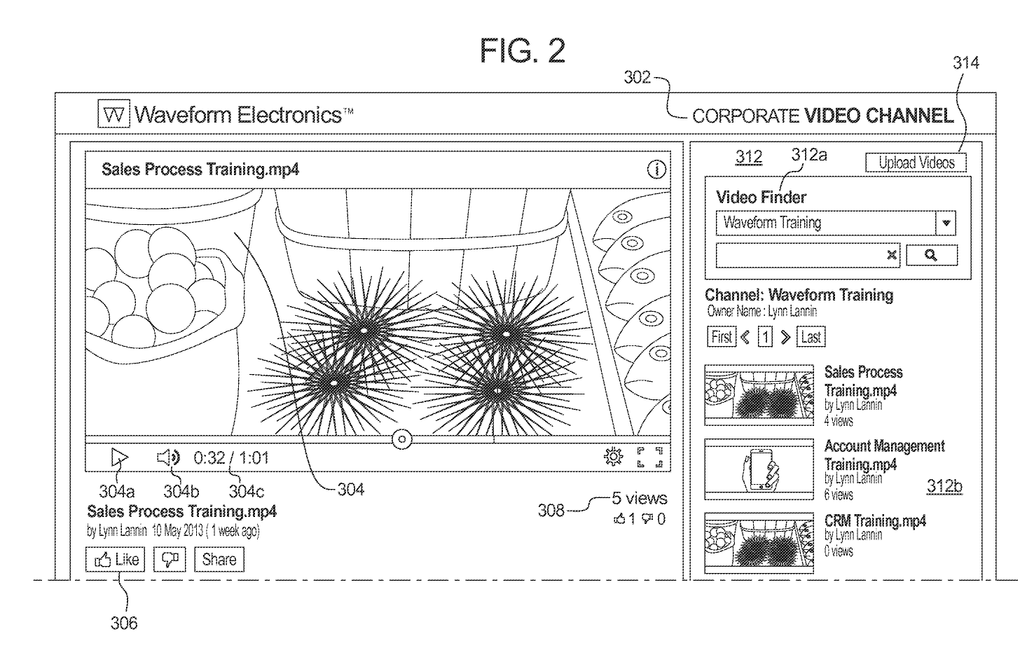

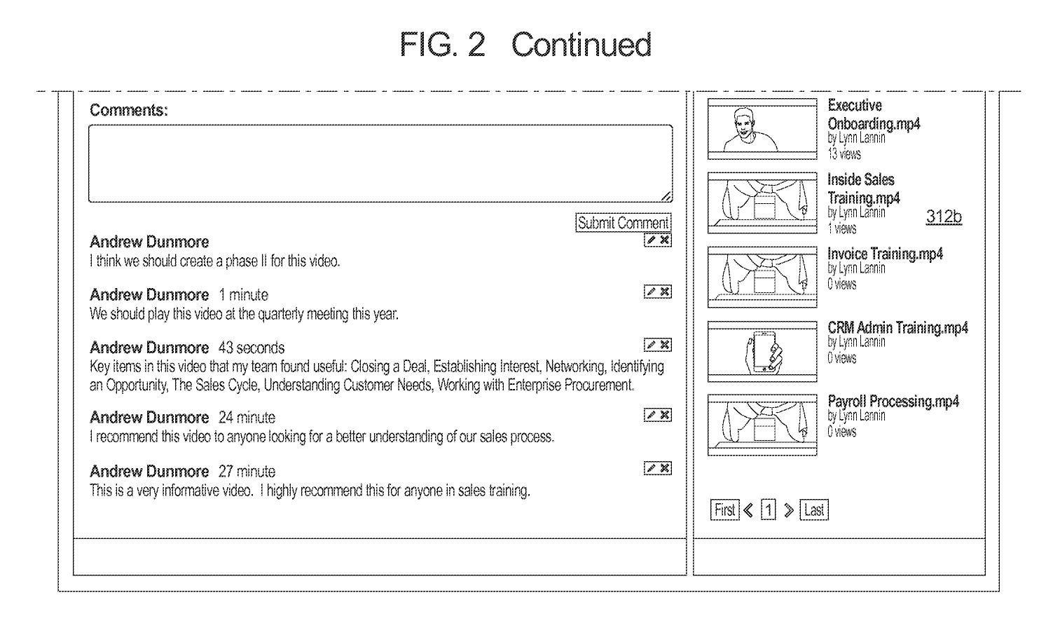

FIG. 2 is an example screen shot of the media content management system disclosed herein, as viewed from the perspective of the user of the system. Specifically, FIG. 2 illustrates a screen shot 300 showing the interface a user of one embodiment of the disclosed system sees when accessing an enterprise video distribution system.

In the illustrated embodiment, area 302 contains branding of the enterprise providing the video content to the user, such as a corporate name and a title of the enterprise video system. Area 304 contains a video viewing area. In area 304, the user can view video stored in a database of the disclosed system, which video is made available to the user based on authenticated login information. Area 304 includes a plurality of controls along the bottom of the video, including a play/pause button 304a, a volume control 304b, an indicator of time elapsed and time remaining 304c, and a video controls/options area 304d. In various embodiments, area 304d includes closed captioning controls, full-screen controls, and/or video quality controls.

In addition, as illustrated by FIG. 2, the disclosed system displays a pair of like/dislike buttons 306 to enable a user to provide binary feedback about the video (i.e., whether the user liked or disliked the video). In other embodiments, the feedback area enables a user to rank a video, such as on a scale of 1 to 10, to indicate whether the user liked or disliked the video. Area 308 indicates both the number of views of the video and the number of “likes” and “dislikes,” which in one embodiment helps subsequent users decide whether they want to view the video.

The embodiment 300 disclosed in FIG. 2 also provides a user comments area 310, which enables users to provide comments as feedback to the video. As illustrated in FIG. 2, at least two users have provided feedback about the video presently being displayed in area 304.

The illustrated embodiment includes a right menu 312, in which various controls are provided for searching and/or filtering videos available to the user. For example, area 312a provides the ability for a user to select a channel and/or search videos by keyword. In one embodiment, the disclosed system enables the user to filter by channel and to search by keyword. In this embodiment, therefore, the user can search by keyword for content within a specific channel. In another embodiment, these options are exclusive-in other words, a user can filter videos of a certain channel, or search by keyword, but not both at the same time. In area 312b, the disclosed system is configured to display videos that match the search parameters provided in area 312a, whether the use searched by video channel, keyword, or both.

In one embodiment, the disclosed system enables the content provider to create so-called feature content that is displayed at the top of the list of videos in the area 312b. For example, a content provider may determine that a newly-created video should be a featured video, or may determine that a video that has received the most user feedback should be a featured video. In these embodiments, the system enables the content creator to promote the featured videos to the top of the display area 312b, such that users are most likely to consume those featured videos.

It should be appreciated that in various embodiments, the disclosed system enables content generators to define one or more channels into which content fits. For example, in the embodiment of FIG. 2, the corporate entity generating content for consumption by its employees may define a “corporate training” channel and a “corporate culture” channel, such that users of the system could easily filter their search results to only videos relating to those topics.

Finally, in the embodiment of FIG. 2, the disclosed system provides an “Upload Videos” control 314 which enables the user to upload a video to the enterprise video hosting system. In one such embodiment, the disclosed system enables the user to select a video from the hard drive of his or her computer for upload to the database storage of the disclosed system. In another embodiment, wherein the user is accessing the website 300 on a device with a camera connected such as a smart phone, tablet or notebook computer, the system enables the user to create a video and upload it by selecting control 314.

In various embodiments, the disclosed system enables a user to upload videos from a branded application affiliated with the enterprise or the content provider. In one embodiment, the disclosed system enables a user to upload data from a native video camera application of a smart phone, tablet, or other computing device, such that the user does not even need to close the video camera application to upload the videos.

It should be appreciated that the embodiment 300 of FIG. 2 is exemplary in nature, and shows an example layout and example placement of example controls. Other controls readily understandable to be usable with video playback systems could also be provided as appropriate to a particular application.

In one embodiment, the disclosed system advantageously enables an enterprise to implement a large-scale content distribution system to distribute content securely to only users selected and authorized by the enterprise. In the embodiment of FIG. 2, the system further provides the users with an easy to understand user interface that can be customized by the enterprise as desired. The interface of FIG. 2 can further be adapted for display on myriad different devices, such as desktop computers, notebook computers, tablets, smartphones, or any other suitable device. Further, as will be discussed below, the cloud-based nature of the hosting of content in the system of FIG. 2 means that users can access the content from anywhere, so long as they provide access credentials (e.g., user name and password).

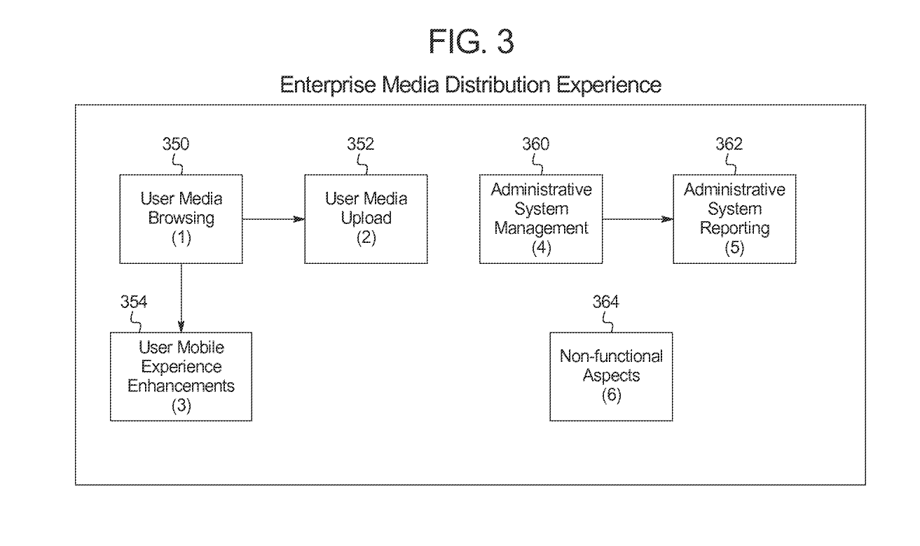

FIGS. 3 to 11 are flow charts of example work flows enabled by various embodiments of the disclosed system. It should be appreciated that each of FIGS. 3 to 11 can be implemented by a system such as that depicted in FIG. 1, in which a remote user accesses stored content via the internet or other suitable network.

FIG. 3 is an overall flow chart of an enterprise media distribution experience. Specifically, as illustrated in FIG. 3, the overall enterprise media distribution experience disclosed herein can involve user media browsing 350, from which experience a user can transition to user media upload 352 or user mobile experience 354, which includes certain enhancements specific to the mobile experience. Likewise, the disclosed system provides for an administrative system management function 360 and an administrative system reporting experience 362. Finally, there are certain non-functional aspects 364 of the disclosed enterprise media distribution experience that will be discussed in detail below.

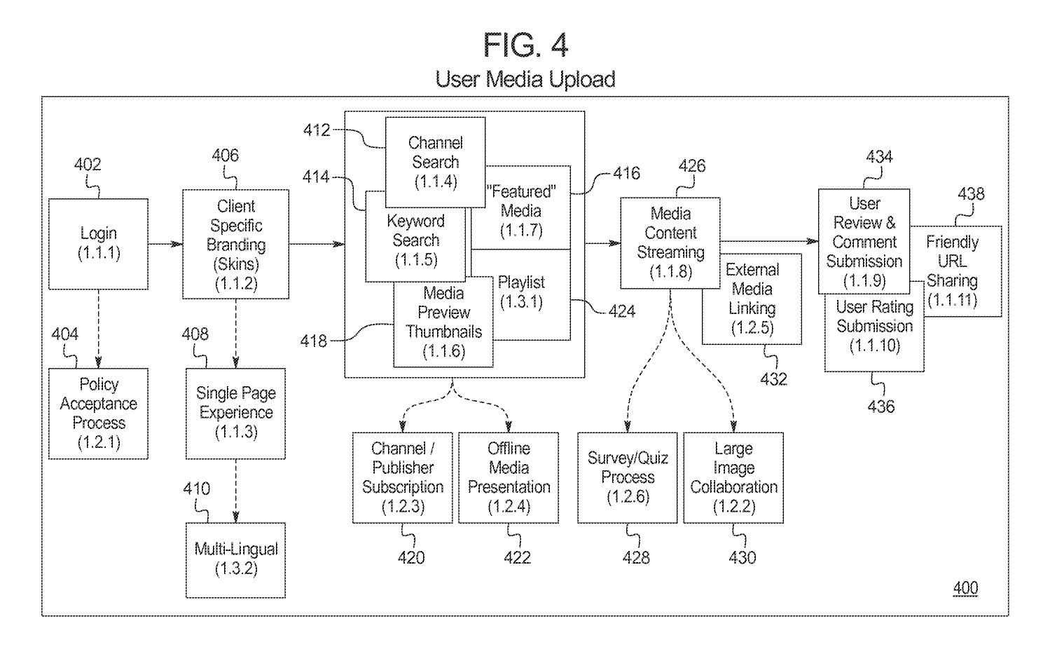

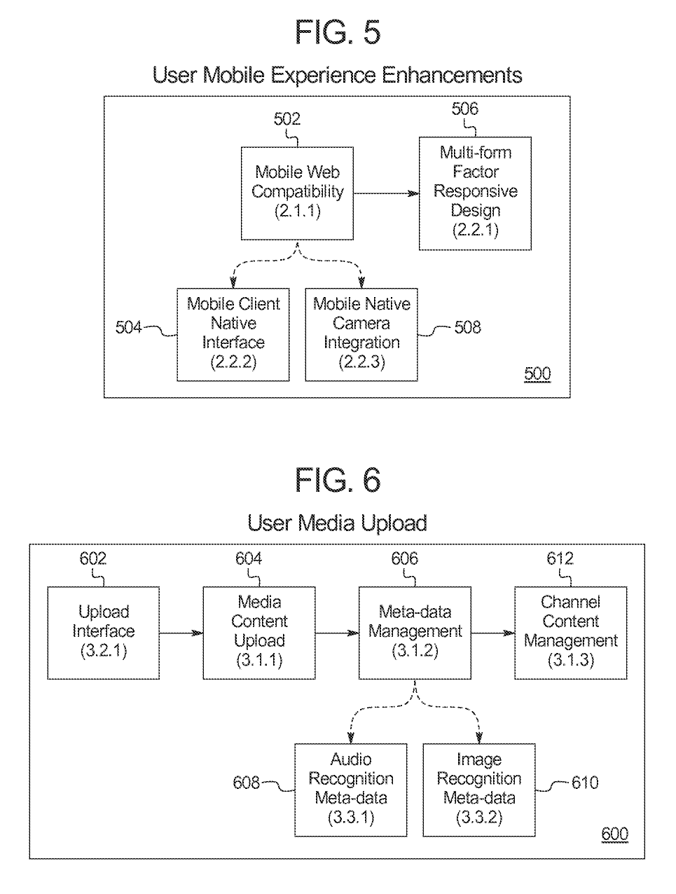

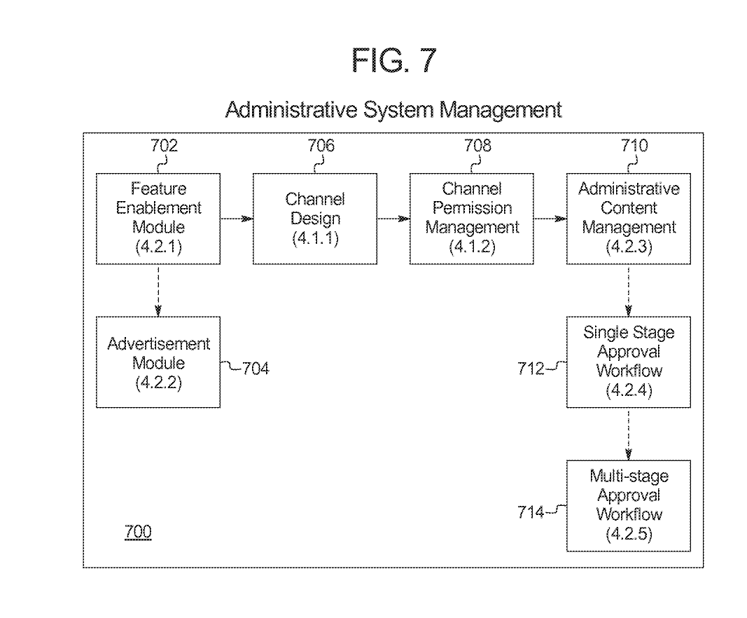

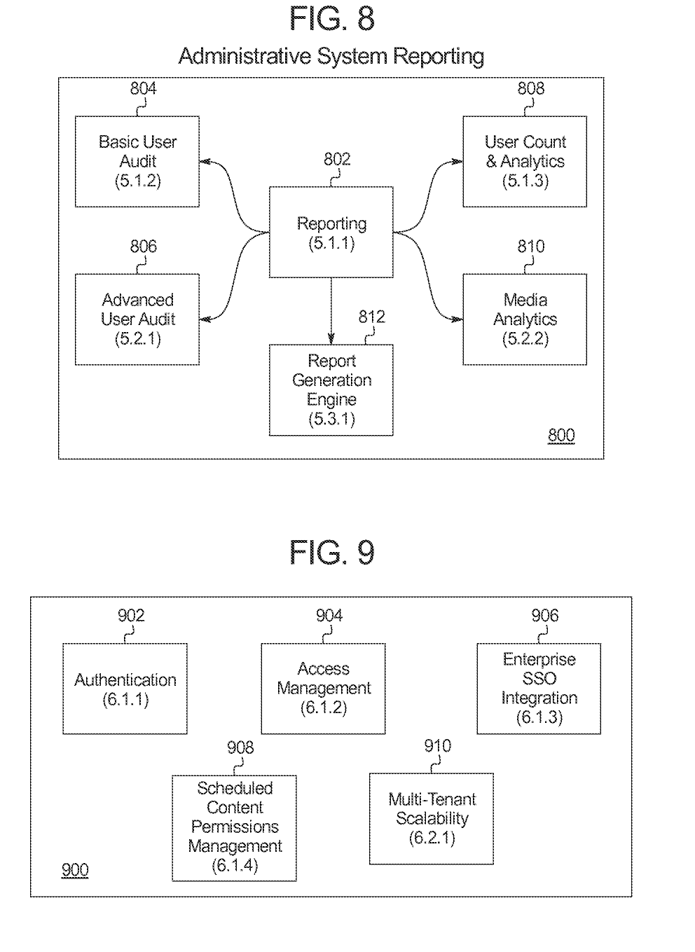

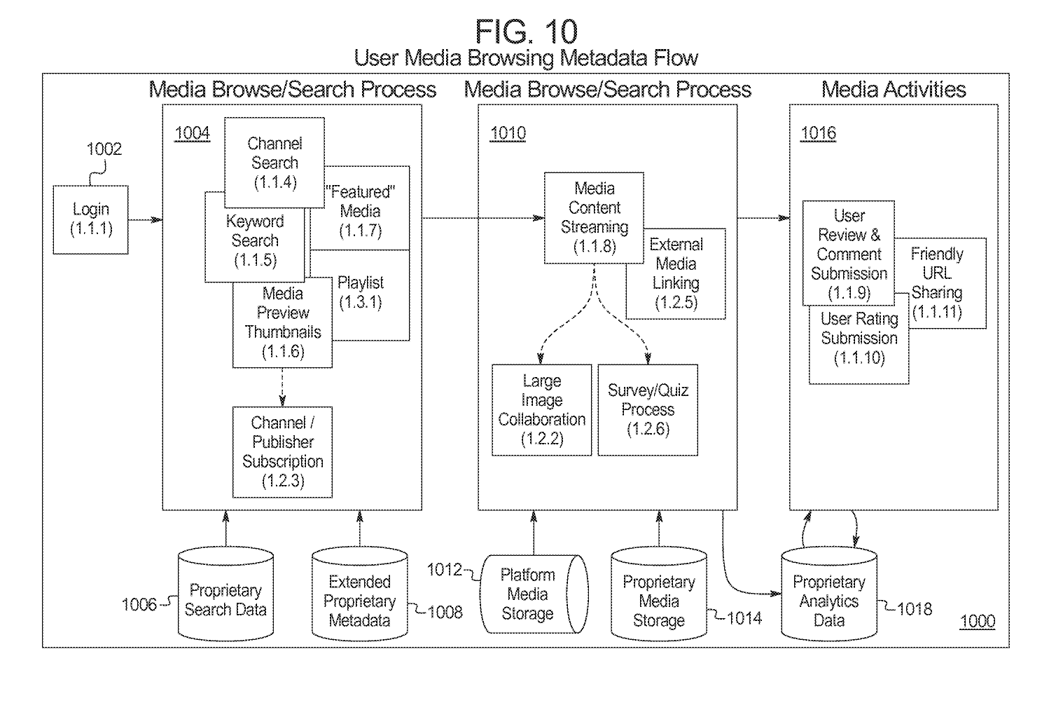

By way of summary, the user media browsing experience 350 is described in more detail with regard to FIG. 4 below, the user media upload experience 352 is described in more detail with regard to FIG. 6 below, and the user mobile experience enhancements experience 354 is described in more detail with regard to FIG. 5 below. The administrative system management experience 360 is described in more detail with regard to FIG. 7 below, and the administrative system reporting experience 362 is described in more detail with regard to FIG. 8 below. Finally, certain non-functional aspects of the experience provided by the disclosed system are described in more detail with regard to FIG. 9 below.

FIG. 4 illustrates some of the details of the user media browsing experience 400 provided by the disclosed system. In the illustrated embodiment, the user can begin the media browsing experience by logging in, as indicated by block 402. For example, the user may provide a user name and password to validate that the user is, in fact, allowed to access the enterprise media provided through the disclosed system. In one embodiment, upon logging in, the system provides a usage policy acceptance screen to the user, as indicated by block 404. In this embodiment, the user must accept the usage policy to proceed.

In one embodiment, the system provides the user with a media display interface including client-specific branding (such as skins), as indicated by block 406. As indicated by block 408, this may feel to the user like he or she is on a single page, and that the single page is affiliated with or provided by the enterprise providing the media. For example, if a user is employed by a company X, the disclosed single page for media consumption may mirror the look and feel of company X's intranet or other branded web properties.

In a further embodiment, the disclosed system provides the interface to the user in multiple languages, as indicated by block 410.

In one embodiment, upon logging in and viewing the enterprise-branded interface, the user is provided with many options. For example, the user may be provided with the option to search by channel, such that media within a selected channel is provided to the user for consumption, as indicated by block 412. Likewise, the user may be presented with an interface to search by keyword, as indicated by block 414. The disclosed system in one embodiment also enables a user to select from a list of featured media, which in one embodiment constitutes media promoted or otherwise highlighted by the enterprise. This functionality is indicated by block 416. In various embodiments, as illustrated by block 418, the disclosed system displays results of searches or filters, or displays featured media, by displaying media preview thumbnails.

As a result of the foregoing navigation of media available to the user, the disclosed system enables the user to see subsets of the total set of available media. As a result of any of this navigation, the system in one embodiment enables the user to create a playlist of media by selecting one or more pieces of media to add to the playlist, as indicated by block 424. For example, the user may add a piece of media that was “featured” content and may also add a piece of media that was the result of a keyword search to the user's to-watch playlist.

In one embodiment, the disclosed system enables a playlist to facilitate a series of incremental media consumption experiences. Specifically, in one embodiment, the disclosed system enables a user to add content to a playlist and begin consuming the first piece of content. In this embodiment, after the system finishes outputting the first piece of content, it sequentially and automatically proceeds to the second piece of content, and so on, until all the content in the playlist has been output.

In various embodiments, the disclosed system enables channel/publisher subscription, as indicated by block 420, or for offline media presentation, as indicated by block 422. In one such embodiment, blocks 420 and 422 represent sub-processes that can result from the various user interactions described above with regard to blocks 412, 414, 416, 418, and 424. In this embodiment, the channel/publisher subscription block 420 represents a user's ability to express interest in either the channel that a video belongs to or the publisher that created the current video. The user's decision to subscribe would demonstrate a current/future intent to view other content that also fits those criteria. In one such embodiment, the system responds to this intent to view other content by suggesting other content (already uploaded or subsequently uploaded) that is in the indicated channel or is provided by the indicated publisher. In one embodiment, the subscription aspect of block 420 is implemented by the disclosed system providing the user with a notification (either active or passive) to inform the user that there is new content that meets the criteria.

In the illustrated embodiment, block 422 indicates the functionality provided by the disclosed system to enable a user to select particular content and make it accessible while not connected to the Internet. In this embodiment, the disclosed system enables the user to indicate a desire to consume particular content offline. Upon receiving such an indication, the disclosed system pushes the desired content to the user for viewing offline.

With any of these options, the disclosed system may perform the described searching/filtering based on information about the media that is visible to the user (e.g., the title) or information about the media that is hidden from the user (e.g., metadata descriptions of the media).

As discussed above, the disclosed system enables consumption of media by users of the disclosed system. To this end, block 426 indicates that searched for, filtered, or playlist media can be streamed to the user, such as by streaming the media from a cloud-based storage location to the user's client machine.

In an embodiment, in addition to consuming the media, the disclosed system enables the user to interact with the media and to provide feedback. For example, in the embodiment of FIG. 4, block 428 indicates that a user may participate in a survey/quiz process after viewing the media. In this embodiment, if an enterprise wishes to ensure that its users have indeed consumed a particular piece of content, the disclosed system enables the enterprise to require that the user complete a quiz or survey at the end of the media consumption. By receiving satisfactory results from the survey or quiz, the enterprise can rest assured that the user has indeed consumed the media as desired. In certain embodiments, the disclosed system also provides a control to enable the user to indicate that he or she is still watching. For example, in one such embodiment, the disclosed system is configured to provide an input box every 10 minutes, and to require the user to click a button in the box, to confirm that the user is still watching. Thus, the disclosed system enables enterprises to ensure that certain media has been consumed in full by requiring users to verify their continued consumption of media during streaming.

In one embodiment, the disclosed system enables users to collaborate with regard to large images or other large image files, as indicated by block 430. Specifically, in one embodiment, users desire to consume images whose storage size is prohibitive to maintaining local copies of the image, such as images up to 1 GB. In this embodiment, the disclosed system facilitates large image collaboration by creating tiles of various sub-sections of the image at various levels of resolution. Thus, for a single image, the disclosed system may store many different version of the image at many different resolutions. Further, the system may store several tiles for each stored resolution. The system then enables users to navigate the image in a conventional way, serving the appropriate tile and/or the appropriate resolution level depending on the zooming and scrolling performed by the user. In other embodiments, the same concept can be applied to high resolution content other than images, such as high resolution video.

In one embodiment, the disclosed system enables users to provide and/or actuate links to external media, as indicated by block 432. In this embodiment, users of the disclosed system can identify content that they would like to be searchable, contained within a channel, and access-managed by the disclosed system. In this embodiment, however, the reference to “external media” means that the content does not reside within the data store or database of the disclosed system. To implement this functionality, this embodiment of the disclosed system determines the content type of the content linked to by an external link and enables the user to connect to the stored content. In this embodiment, while the disclosed content is stored externally, the disclosed system stores all other data (e.g., related to channels, metadata, etc.) needed to integrate the content on a local data store or database. In an embodiment, the disclosed system thus enables entities that have content stored in existing web content management systems or enterprise content management systems to ensure that the current content can nonetheless be integrated into the disclosed system. In a further embodiment, the disclosed system handles the negotiation of access to the content in a transparent fashion, such as by providing stored access information including a user name and login password, such that the user does not experience the content as being external content. In another embodiment, the disclosed system requires the user to provide separate access information to access the externally stored content.

The disclosed system also provides for various feedback mechanisms after the user has finished consuming content. For example, as illustrated by block 434, the disclosed system enables the user to review and submit comments about media. Likewise, the disclosed system enables the user to submit ratings for content, such as by selecting a “like” or “dislike” icon, as indicated by block 436. Finally, the disclosed system also enables users to share URLs for media, as indicated by block 438. As discussed above, in various embodiments such sharing can only occur between users that each has access to the media whose URL is being shared.

FIG. 5 is a flow chart 500 of a series of blocks indicating enhancements provided by one embodiment of the disclosed system to enable the system to be used in mobile environments. Initially, the disclosed system provides an interface, such as the interface 300 discussed above with regard to FIG. 2, in a form that is compatible with known mobile browsers, as indicated by block 502. In one such embodiment, the disclosed system provides such compatibility by providing mobile client native interfaces in the form of platform-specific applications, as indicated by block 504. In another embodiment, the disclosed system provides for such compatibility by ensuring that the design of the interface 300 is created with multiple form-factors in mind, as indicated by block 506.

Finally, as illustrated by block 508, the disclosed system in one embodiment enables a user to use a native camera in a mobile platform to record and upload his or her own content, be it original content for consumption or media content indicating feedback about consumed content, as illustrated by block 508. FIG. 6, discussed in more detail below, provides a more detailed flow chart 600 of some of the steps involved in user media upload.

Referring now to FIG. 6, the disclosed system provides a user with a user media upload interface, as indicated by block 602. In various embodiments, the interface enables the user to select media content for upload, as indicated by block 604. For example, the disclosed system may enable the user to select media content already stored on his or her local device, or may enable the user to capture media content in real time, such as through a built-in camera.

The disclosed system also enables a user uploading media content to manage the meta-data of the uploaded content, as indicated by block 606. In this embodiment, the disclosed system enables the user to provide information that will be stored as metadata, such as a description of the content to be uploaded content. In a further embodiment, the disclosed system also provides audio and image recognition capability for generating metadata, as indicated by block 610. This functionality enables the automatic recognition, extraction, and storage of metadata.

In various embodiments, the metadata includes any appropriate data that provides searchable information about the content beyond the content itself. For example, in various embodiments, the disclosed system stores the following as metadata usable as described herein:

(1) Unstructured data such as blocks of text;

(2) Structured data composed of a collection of unstructured string data such as a collection of short tags;

(3) Date/time information such as date create, date modified, publication date;

(4) Numeric data;

(5) Image recognition data that collects a knowledge graph of image related information; and/or

(6) Audio recognition data such as mood, tempo, recognized voice.

In some embodiments, the metadata stored in association with content by the disclosed system is provided by the user. For example, the data indicated by metadata types (1), (2), (3), and (4) above in various embodiments is provided by a system administrator, uploader, or other user entering the data via a keyboard or other input device. In various embodiments, the metadata types (5) and (6) is automatically generated, such as by applying image processing or audio processing algorithms to content to extract data about the content.

In one embodiment, as part of the user media upload process 600, the disclosed system also enables the user to specify channel(s) into which the uploaded media should be placed. For example, the disclosed system may enable a user to specify that uploaded content pertains to a product review of a product sold by the enterprise managing the disclosed system.

FIG. 7 is an example flow chart of a process 700 for administering one embodiment of the disclosed system. Process 700 includes the ability of a system administrator to enable and/or disable various features, including those features discussed herein, as indicated by block 702. For example, in one embodiment the disclosed system enables an administrator to turn on or turn off a comments feature, thus either enabling or disabling users to provide feedback about videos they have viewed. Block 704 indicates that an administrator of the disclosed system can also enable an advertisement module, by which advertisements or other branded communications are pushed out to users of the disclosed system.

The disclosed system also enables an administrator to manage content-related aspects of the user experience. For example, as indicated by block 706, the disclosed system enables an administrator to create and design channels, such that when a user selects a particular channel, the user will experience the channel as desired by the administrator. Likewise, the disclosed system enables the administrator to adjust permissions (i.e., access rights) on a channel-by-channel basis, as indicated by block 708. Finally, the disclosed system enables the administrator to manage the content actually made available to users, as indicated by block 710. For example, the disclosed system enables the administrator to obtain approval for content in a single stage workflow (block 712) or a multi-stage workflow (block 714).

FIG. 8 is an example flow chart of a process 800 for administrative system reporting. Specifically, according to the embodiment of FIG. 8, the disclosed system provides a reporting function as indicated by block 802. As discussed in detail below, the remaining blocks of FIG. 8 represent different reporting options that the disclosed system can provide to administrators in different embodiments.

In one embodiment, the basic user audit block 804 represents a capability of the disclosed system to report what content a particular user has uploaded, what that user has shared and with whom, what the user has indicated he or she likes or dislikes, and what comments the user has provided. In short, in this embodiment, the basic user audit block 804 enables the disclosed system to capture initial information auditing a user's activity.

In one embodiment, the advanced user audit block 806 represents a capability of the disclosed system to obtain more detailed, more involved reports of user activity. For example, in various embodiments the disclosed system tracks user attentiveness (such as by requiring the user to click a button confirming he or she is still watching or by administering a test after the content is done being consumed). In one such embodiment, the advanced user audit includes a report of the user's attentiveness. In other embodiments, additional advanced audit features are enabled by the block indicated as 806, such as audit features that analyze a user's comments to determine a user's perception of the content.

In one embodiment, the user count and analytics block 808 represents a capability of the disclosed system to abstract data about individual user activity, such as the activity discussed above with regard to blocks 804 and 806, and aggregates the data. In this embodiment, the data generated by the user count and analytics block provides user group behavior analysis. For example, in one embodiment the disclosed system provides statistics about a number or percentage of users who have consumed a particular piece of content, who have subscribed to a particular channel, who have performed the same or similar searches, and the like.

In one embodiment, the media analytics block 810 represents a capability of the disclosed system to generate reports associated with content assets. For example, the disclosed system may track and provide reporting on how often a video was viewed, who viewed a video, what the average viewing time of a video was, and the like.

In the illustrated embodiment, the disclosed system also provides a report generation engine, represented by block 812. In this embodiment, the report generation engine 812 enables users (including consumers of content and/or administrators of the disclosed system) to create reports that span the various data collection and reporting functionality described with regard to blocks 802, 804, 806, 808, and 810. For example, in one embodiment the disclosed system enables users to create reports that include user data, media data, and/or aggregated data summarizing consumption of the content.

The disclosed system also provides for certain non-functional aspects, as indicated by the chart 900 illustrated in FIG. 9. For example, the disclosed system provides an authentication function, by which user login information is authenticated, as indicated by block 902. Upon authenticating a user, the disclosed system also implements an access management functionality, as indicated by block 904. According to one embodiment of this functionality, a user is provided with access to certain media content based on the result of the authentication. For example, if a user is an employee of an enterprise, the user may be provided with access to a library of employee training materials. However, if a user is an executive of an enterprise, the disclosed system may provide the user with access not only to the employee training materials, but to an additional library of executive training and management materials.

Referring still to the embodiment of FIG. 9, block 906 represents enterprise single sign-on integration. In one embodiment, the disclosed system enables integration with enterprise customers that have a federated authentication and authorization system known as single-sign on (SSO). In this embodiment, this capability enables users of the disclosed system to only have to log in once to access disclosed system capabilities or enterprise corporate assets. Along with integration of the authentication process, the disclosed system also uses enterprise SSO integration for authorization. In this embodiment, users and groups defined in a corporate user directory can be used to secure content to selective users or groups of users of the disclosed system, without those users needing to re-authenticate their use of the disclosed system. It is believed that these two capabilities are a critical element in ease of use for customers.

In the illustrated embodiment, block 908, relating to scheduled content permissions management, represents a process for addressing some short-comings of known platform authentication systems. Specifically, these shortcomings of some known platforms involve the inability to grant permissions to groups of users when the users are added to the system as a group. In one embodiment, the disclosed system is configured, on a scheduled basis, to review content permissions to ensure that all users have access to the proper content. In an embodiment, this process is repeated to address the asynchronous lag in indexing content that results after content has been uploaded. In other words, in one embodiment, the disclosed system refreshes the permissions of all the content in the system on a periodic basis to ensure that users can access the content to which they have permission.

Referring still to FIG. 9, block 910, relating to multi-tenant scalability, represents the system's capability to host multiple customers on the same deployed system. In one such embodiment, the disclosed system can support multiple customers by utilizing security boundaries and access permissions strictly isolated between customers. In this embodiment, efficiency is achieved by allowing multiple customers to leverage shared memory and compute services.

FIG. 10 illustrates an example user media browsing metadata flow 1000. The illustrated flow begins when a user logs in, as indicated by block 1002. Thereafter, the user can participate in the various sub-processes of the media browse/search process 1004, the details of which were discussed above with regard to FIG. 4. In the embodiment of FIG. 10, the process also includes inputs in the form of proprietary search data 1006 and extended proprietary metadata 1008. For example, in various embodiments proprietary metadata includes one or more of content specific data fields such as date created, date uploaded, and associated tag text. In various embodiments, extended proprietary data includes one or more of vertical industry specific metadata that may include information such as geographic location, purpose of media, and quality of content.

It should be appreciated that by providing this data as input to the media browse/search process, the disclosed system enables an enterprise to make its media content easily and readily searchable, such that authorized users of the disclosed system can easily find desired media.

FIG. 10 further illustrates, the media browse/search process 1006. In one embodiment, the process 1010 corresponds to the discussion of FIG. 4 provided above. Further, in the embodiment illustrated in FIG. 10, it can be seen that a block called “platform media storage” 1012 and a block called “proprietary media storage” 1014 enable the media browsing and feedback illustrated in block 1010. In other words, the blocks 1012 and 1014 represent, schematically, the storage devices that store both the media streamed to the user as part of process 1010 and the information needed to enable media linking, large image collaboration, and the survey/quiz process illustrated in process 1010.

Process 1016 illustrates an embodiment of some of the activities a user can perform during or after consuming content distributed via the disclosed system. These activities are discussed above in more detail with regard to FIG. 4. Block 1018 represents storage of proprietary analytics data resulting from both the user's consumption activities and the user's post-consumption activities. For example, in the illustrated embodiment, an arrow from process 1010 to block 1018 indicates that data about a user's streaming history is stored as proprietary analytics data. Thus, for example, the disclosed system can track the amount of data streamed, a listing of the videos streamed, the identity of the users streaming data, whether and to what extent the users completed streaming, and the like. Also, because data output from process 1016 is provided as input to proprietary analytics data block 1018, the disclosed system can capture all user feedback such as comments and ratings, and can also capture information about a user's post-consumption sharing activities.

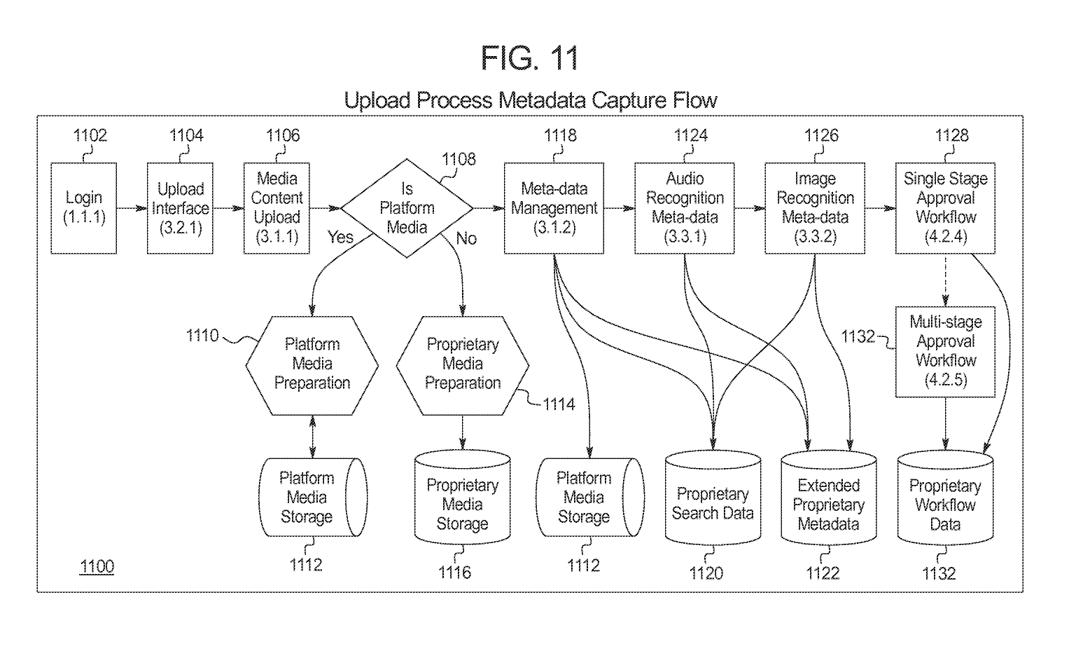

FIG. 11 illustrates a process 1100 for capturing metadata during the upload of content. In various embodiments, process 1100 applies when the enterprise uploads content, when a user uploads content, or both. Process 1100 begins when the user logs in, as indicated by block 1102, and is presented with an upload interface, as indicated by block 1104. Next, the disclosed system enables the user to upload the media content, as indicated by block 1106. The steps associated with media upload are discussed in more detail above with regard to FIG. 6.

In one embodiment, after receiving uploaded media, the disclosed system makes a determination as to whether the media is platform media, as indicated by block 1108. In various embodiments, media is platform media if the disclosed system supports playback of that media natively. In an example embodiment, platform media includes video content, image content, and audio content. In various embodiments, if media is not platform media, it is proprietary media. In one such embodiment, proprietary includes non-standard data such as large image data (with appropriate tiling and resolution information), external link content, video count data, thumbs up/thumbs down data, and/or geospatial data intended to be applied to a map. It should be appreciated that depending on the native capabilities of the disclosed system, the distinction between platform and proprietary media could change from implementation to implementation.

If the media is platform media, the disclosed system prepares the platform media, as indicated by block 1110, and stores the media on platform media storage 1112. If, on the other hand, the media is proprietary media, the disclosed system prepares the proprietary media, as indicated by block 1114, and stores the proprietary media on proprietary media storage 1116.

After storing the media in the appropriate location, the disclosed system begins the meta-data management process, as indicated by block 1114. The blocks across the top of FIG. 11 in one embodiment illustrate various processes that are involved in metadata management, while the cylinders across the bottom represent various data stores, databases, or other data storage solutions. In the illustrated embodiment, the metadata management processes 1118, 1124, 1126, 1128, and 1130 represent mechanisms for inputting or otherwise obtaining metadata about content under management by the disclosed system.

Block 1118 of FIG. 11 represents a user providing metadata to the system for storage in association with the content managed by the system. In one embodiment, the arrow between block 1118 and cylinder 1112 indicates that certain metadata is stored in the same data store as platform media. For example, the title of a video on a platform configured to support video playback may be stored in the platform media storage. The arrows from block 1118 to cylinders 1120 and 1122 indicate that proprietary search data and extended proprietary metadata are stored in data stores 1120 and 1122, respectively, if the content is proprietary content.

Blocks 1124 and 1126 represent audio processing and image processing techniques that can be used to extract metadata. In other words, blocks 1124 and 1126 are machine-oriented processes of creating metadata based on audio or video processing algorithms. For example, by applying an appropriate image processing algorithm to a piece of video content, at block 1126, the disclosed system may be able to ascertain that a video is a training video (e.g., if the characters “Training” are detected in one or more frame of the video). In this embodiment, metadata indicating that the video is a training video is stored in either the proprietary search data store 1120 or extended proprietary metadata 1122, as appropriate.

In the illustrated embodiment, blocks 1128 and 1130 represent either single stage approval (block 1128) or multi-stage approval (block 1130) for uploaded content. These workflows both refer to the number of stages of approval (e.g., the number of individuals) required before uploaded content can be made available to users of the disclosed system. In one embodiment, information about the approval workflow (such as the person or persons who approved the content, the time and date of approval, etc.) is stored in the proprietary workflow data store 1132. In a further embodiment, this data can be used to generate one or more of the reports discussed with regard to FIG. 8.

In the embodiments illustrated in both FIG. 10 and FIG. 11, the various storage devices (or data stores) are represented as cylinders. In the illustrated embodiments, cylinders that are depicted in a horizontal alignment represent databases or data stores that are already supported by known content storage systems, such as known cloud storage systems. In these embodiments, cylinders that are illustrated in a vertical alignment represent databases or data stores that are not supported by known content storage systems, and that are therefore provided by the architecture of the disclosed system, such as storage device 218 of FIG. 1.

In various embodiments, the system disclosed herein can be integrated with existing enterprise portals or intranets, such that the consumers of media do not have a substantially different user experience interacting with the disclosed media consumption system.

In various embodiments, the disclosed system also enables the creation of rules for auto-management of videos. For example, one embodiment of the disclosed system enables an administrator to specify a time and/or date for auto deletion of videos. In another embodiment, the disclosed system enables an administrator to specify that after a certain amount of time has passed, the administrator must review a video to ensure it is not removed from the disclosed system.

In one embodiment, the disclosed system provides subscription functionality. In this embodiment, a user can subscribe to a particular subset of videos, such as by subscribing to videos in a particular channel or to videos that match a certain keyword search criteria. In this embodiment, the system provides notification to the user whenever a new video matching the user's subscription becomes available for viewing.

In various embodiments, as discussed above, the disclosed system provides enterprises with certain tracking functions. For example, in one embodiment the disclosed system tracks which users have viewed a video based on the users' login information. In a further embodiment, the disclosed system tracks which users viewed a video to completion. In another embodiment, the disclosed system provides users with a quiz either during or after viewing a video, the results of which can indicate whether the user watched the entire video.

In one embodiment, the disclosed system displays one or more bar codes, QR codes, or other identifying symbologies in association with various pieces of served content. In this embodiment, the user can scan the symbology, such as using a smart phone or other scanner, to obtain additional information related to the content consumed. For example, if a user watches a safety training video, a QR code displayed in association with the video may link the user to a URL of a safety manual, where the user can go for additional safety information.

In one embodiment, the disclosed system provides an administrator with the capability of reviewing and/or authorizing all uploaded content prior to that content becoming widely available. For example, in one embodiment each uploaded piece of content is queued in an administrator workflow, and requires an administrator with sufficient privileges to review and affirmatively enable the content to be consumed by a wider audience of consumers.

In one embodiment, the system disclosed herein is configured for use primarily by users who are online at the time of access. In another embodiment, the system disclosed herein enables users that do not have a network connection to view content by caching the content locally for offline consumption. In one embodiment, this functionality enables content to be “downloaded” and redistributed as desired. In another embodiment, the content is cached on a user's device but is prohibited from being redistributed based on an appropriate digital rights management technique.

In various embodiments, the system disclosed herein enables the creation of reports based on data collected about users that have consumed content. For example, the disclosed system in one embodiment provides a dashboard for administrators that enables the administrators to generate reports about users that have consumed certain content. In an embodiment, such reports can be generated to indicate which users began but did not complete consumption of content. In other embodiments, the dashboard enables administrators to generate reports summarizing or aggregating feedback provided by users.

In one embodiment, while the majority of content provided by the disclosed system is provided by or attributable to an enterprise, the disclosed system also enables third-party (i.e., public) videos to be linked-to using the disclosed system as an interface. Thus, for example, if an enterprise posts a video about factory safety specific to a particular facility, the enterprise can nonetheless link to publicly available videos created and maintained by public safety organizations (such as OSHA) as further resources or required viewing.

In one embodiment, in which content is designed for consumption in factory floors or other dirty environments, it is desirable to enable users to search for and consume content without touching the device that provides the content. As a result, in one embodiment, the disclosed system utilizes one or more touchless input devices, such as one or more microphones with speech recognition capability, to enable a user to access content provided by the disclosed system. In another embodiment, the disclosed system includes an input device capable of recognizing gestures without the user needing to touch the device.

In one embodiment, the system disclosed herein includes a feature for repeat or queued play. The notion of playlists was discussed above, but in a further embodiment the system enables a user or administrator to indicate that a particular piece of content or series of pieces of content should be played back on repeat. In this embodiment, the disclosed system would find applicability in common areas, such as break rooms or waiting rooms, such that desired content could be passively consumed by individuals who happen to be in such rooms.

In one embodiment, the network of computers used to host and serve content as described herein is proprietary and is owned or controlled by the enterprise responsible for creating and distributing the content. In another embodiment, the disclosed system leverages in-place cloud computing resources, such as storage, authorization, access control, and searching resources, to deploy enterprise-specific content to disparate content consumers without requiring the enterprise to invest in expensive infrastructure that would otherwise be required.

In one embodiment, the system disclosed herein performs authentication by storing user name/password information or other authentication information itself. In other embodiments, the disclosed system is configured to forward user name/password information or other authentication information to the enterprise for authentication. In these embodiments, the enterprise thereafter responds to the disclosed system indicating whether or not the user should be allowed to access the content associated with that enterprise. As a result, various embodiments of the disclosed system enable users to view proprietary enterprise information even when the user is not logged in to the enterprise' Virtual Private Network (VPN) or other proprietary network.

In one embodiment, the disclosed system is implemented with a backend in which file structures do not show up if user permissions are added as members of a group as opposed to individual users. In this embodiment, the disclosed system additionally includes a script that runs periodically to ensure that every user, even if added as a member of a group, has access to all the appropriate content stored in the backend. In this embodiment, for each user that has access to the files (even if the user was added in a group), the script scans through each then-existing file on the backend and “touches” it as if the user had accessed the file. In this way, the system ensures that each user has access to and can see each piece of content to which he or she is entitled, even if the backend is implemented such that users added in a group would not be able to see the content. In an example embodiment, this script runs every hour, such that the maximum amount of time a user would not be able to see a newly added file is one hour. In another embodiment, this script runs every time a user is added to the system, or every time a piece of content is added to the system.

In various embodiments, the disclosed system enables users to search various fields of data. For example, as discussed above, the disclosed system may enable users to search stored content by metadata, title, and/or comments other users have made about the content. In various embodiments, the disclosed system is configured to return search results depending, at least in part.

The disclosed system has generally been referred to as a content distribution system, and content consumers have generally been referred to as users. In certain embodiments, the content has been specifically referred to as video. It should be appreciated that the disclosed system is equally usable to distribute content other than video, such as audio, images, documents, or other content. Accordingly, unless specifically stated, references herein to “content” and “video” should be understood broadly to encompass video and any other kind of appropriate content.

In various embodiments, the instant disclosure has referenced either databases or datastores. It should be appreciated that depending on the desired implementation, databases (such as databases stored on storage devices operated by the provider of content), datastores (such as cloud computing data storage resources), or other appropriate storage mechanisms could be used to store content, metadata, programs, and/or other data described herein.

The above description of is exemplary of the features of the system disclosed herein. As noted, the disclosed system could be used to distribute any type of content to any type of user in an access-controlled environment, and is not limited to enterprise video. Moreover, the functionality of the above-described system is not limited to the functionalities indicated herein. It should be understood that various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claim.

The invention is claimed as follows:

1. A content access management system comprising:
at least one processor;
at least one display device;
at least one input device; and
at least one memory device which stores a plurality of instructions which, when executed by the at least one processor, cause the at least one processor to operate with the at least one display device and the at least one input device to:
(a) store at least one video and metadata associated with the at least one video;
(b) receive user authentication information identifying a user;
(c) determine, based on the user authentication information, whether the user has access to the at least one video;
(d) if the determination is that the user has access to the at least one video:
(i) receive at least one search string from the user;
(ii) if the search string matches at least a portion of the metadata associated with the at least one video, display the at least one video to the user, and
(iii) receive feedback data about the at least one user, said feedback data indicating at least one of a user perception of the at least one video and details about the consumption of the at least one video by the user.

2. The content access management system of claim 1, wherein the feedback data includes at least one user comment.

3. The content access management system of claim 1, wherein the at least one memory device stores a plurality of instructions which, when executed by the at least one processor, cause the at least one processor to store the feedback data as metadata associated with the at least one video for future searching.

4. The content access management system of claim 3, wherein the at least one memory device stores a plurality of instructions which, when executed by the at least one processor, causes the at least one processor to operate with the at least one display device to display a first set of the metadata and not to display a second set of the metadata.

5. The content access management system of claim 1, wherein the at least one memory device stores a plurality of instructions which, when executed by the at least one processor, causes the at least one processor to operate with the at least one display device to display a control to enable the user to share the at least one video with a different user.

6. The content access management system of claim 5, wherein the different user also has access to the at least one video.

7. The content access management system of claim 5, wherein control to enable the user to share includes a list of different users that have access to the at least one video.

8. The content access management system of claim 1, wherein the at least one memory device stores a plurality of instructions which, when executed by the at least one processor, causes the at least one processor to operate with the at least one display device to repeatedly display a control requesting the user to verify viewing of the video.

9. The content access management system of claim 1, wherein the at least one memory device stores a plurality of instructions which, when executed by the at least one processor, causes the at least one processor to operate with the at least one display device to display at least one question about the video following viewing of the video.

10. The content access management system of claim 9, wherein the at least one memory device stores a plurality of instructions which, when executed by the at least one processor, causes the at least one processor to receive at least one answer to the at least one question, and if the answer is incorrect, to operate with the at least one display device to replay the video.

11. A method for accessing content:
(a) storing at least one video and metadata associated with the at least one video in at least one memory device;
(b) receiving user authentication information identifying a user via at least one network interface device;
(c) determining, based on the user authentication information, whether the user has access to the at least one video;
(d) if the determination is that the user has access to the at least one video:
(i) receiving at least one search string input from the user;
(ii) if the search string matches at least a portion of the metadata associated with the at least one video, causing at least one display device to display the at least one video to the user, and
(iii) receiving at least one input containing feedback data about the at least one user, said feedback data indicating at least one of a user perception of the at least one video and details about the consumption of the at least one video by the user.

12. The method of claim 11, wherein the feedback data includes at least one user comment.

13. The method of claim 11, which includes storing the feedback data as metadata associated with the at least one video for future searching.

14. The method of claim 13, which includes causing the display device to display a first set of the metadata and not to display a second set of the metadata.

15. The method of claim 11, which includes causing the display device to display a control to enable the user to share the at least one video with a different user.

16. The method of claim 15, wherein the different user also has access to the at least one video.

17. The method of claim 15, wherein control to enable the user to share includes a list of different users that have access to the at least one video.

18. The method of claim 11, which includes causing the display device to repeatedly display a control requesting the user to verify viewing of the video.

19. The method of claim 11, which includes causing the display device to display at least one question about the video following viewing of the video.

20. The method of claim 19, which includes, if the answer is incorrect, causing the display device to replay the video.
